(19) United States
(12) Patent Application Publication
(10) Pub. No.: US 2008/0290815 A1
(43) Pub. Date: Nov. 27, 2008

(54) LIGHT SOURCE DRIVER

(75) Inventor: Sachiyo YAMADA, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/836,822

(22) Filed: Aug. 10, 2007

(30) Foreign Application Priority Data
Nov. 22, 2006 (JP) 2006-315689
Apr. 4, 2007 (KR) 10-2007-0033374

(51) Int. Cl. H05B 41/36

(52) U.S. Cl. 315/294

(57) ABSTRACT

Provided is a light source driver which drives a light source including a switch unit which selects a light source; a chopper circuit which supplies power from an inductor to a light emitting diode (LED) via a diode in an on-state of a field effect transistor (FET), where the power accumulates in the inductor in the on-state of the FET; an oscillator which outputs a signal such that power is supplied to the LED through the chopper circuit, wherein the power changes according to the inductance of the inductor and the load capacity of the LED selected; and a chopper circuit driving unit which operates the FET in response to a signal whose duty ratio is the same as that used to supply power to the selected LED according to the load capacity of the LED and whose switching frequency is the same as a signal output from the oscillator.

### CROSS-REFERENCE TO RELATED PATENT APPLICATION

This application claims priority from Japanese Patent Application No. 2006-315689, filed on Nov. 22, 2006, in the Japanese Intellectual Property Office, and Korean Patent Application No. 10-2007-0033374, filed on Apr. 4, 2007, in the Korean Intellectual Property Office, the disclosures of which are incorporated herein in their entirety by reference.

### BACKGROUND OF THE INVENTION

1. Field of the Invention

Apparatuses consistent with the present invention relate to a light source driver that drives a light source such as a light emitting diode (LED) used, for example, in a projector.

2. Description of the Related Art

In the related art, LEDs used in projectors are turned on and off with a structure such as that shown in FIG. 7, in which light source drivers 100, 110, and 120 respectively drive a red LED 101, a green LED 111, and a blue LED 121. In the structure shown in FIG. 8(A), turn-on signals R_on, G_on, and B_on, respectively for red, green, and blue colors, are output from a turn-on signal generating circuit 130 by time division. In addition, switches 102, 112, and 122 of the respective light source drivers 100, 110, and 120 are switched to be repeatedly on and off according to a timing sequence shown in FIG. 8(B). Since an LED current changes as shown in FIG. 8(C), the respective light source drivers 100, 110, and 120 operate only when their corresponding switches 102, 112, and 122 are on, and otherwise do not operate (standby state).

Meanwhile, there is market demand for smaller, brighter projectors. To aid miniaturization, a light source driver 200 of FIG. 9, or an LED driver as disclosed in U.S. Patent Application No. 2006/0181485, have been proposed.

The light source driver 200 of FIG. 9 has a structure in which the light source drivers 100, 110, and 120 shown in FIG. 7 are integrated into one driver to be commonly shaped by a plurality of LEDs. Referring to FIG. 9, an LED current is required to turn on LEDs 30-R, 30-G, and 30-B hereinafter, the LED current will be referred to as a “target current”). The LED current is determined by a variable resistor 17 included in the light source driver 200. A turn-on signal generating circuit 16 outputs turn-on signals R_on, G_on, and B_on which are time-divided for the respective red, green, and blue LEDs 30-R, 30-G, and 30-B (FIG. 10A). Switches 15-R, 15-G, and 15-B are switched over in response to the corresponding turn-on signals R_on, G_on, and B_on. The target current changes with the variation of the resistance of the variable resistor 17. Accordingly, an LED on/off state is achieved as shown in FIG. 10B. In FIG. 10C, an LED current always flows, so that the light source driver 200 always in an operation state.

However, according to the structure of the light source driver 200 of FIG. 9, the LED 30-R, 30-G, and 30-B may operate normally when a certain current is provided. For example, when a high current is provided to the LED 30-R, 30-G, and 30-B in order to obtain high brightness, the following problems may occur.

It will be assumed that the inductance of an inductor 11 of a chopper circuit 10 commonly shared by the LEDs 30-R, 30-G, and 30-B is chosen to suit the LED current flowing through the blue LED 30-B. When the LED 30-B is turned on, an inductor current I_{L} flowing through the inductor 11 varies in a normal range ΔI_{L} as shown in FIG. 11(a). As a result, the LED 30-B is reliably turned on.

An LED current required to turn on the LED 30-R is higher than an LED current required to turn on the LED 30-B. Thus, the inductor 11 may be saturated when the LED 30-R is turned on, as indicated by point_a in FIG. 11(b). The flow of the saturated inductor current I_{L} stops the operation of a driver IC 201, which leads to abnormal operation.

On the other hand, when the inductance of the inductor 11 is chosen to suit the LED current flowing through the red LED 30-R, as shown in FIG. 12, the inductor 11 may accumulate insufficient energy when the blue LED 30-B is turned on. In this case, as indicated by point_a in FIG. 12(b), the inductor current I_{L} is interrupted and flashing occurs while turning on the LED 30-B, which leads to abnormal operation.

Therefore, in order to realize high LED brightness using the structure of FIG. 7, the light source driver cannot be commonly shared by a plurality of LEDs. However, this adds expense and hinders miniaturization. Accordingly, there has been a problem that miniaturization and high brightness cannot be achieved at the same time.

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

An aspect of the present invention provides a light source driver which drives a light source such as an LED and can realize miniaturization and high brightness.

According to an aspect of the present invention, there is provided a light source driver driving a plurality of light sources each having a difference load capacity, comprising: a switch unit which selects any one of the light sources by switching from one light source to another; a chopper circuit which has an inductor connected to a power source, a diode connected to the light source selected by the switch unit, and a switching element supplying power accumulated in the inductor to the light source through the diode by controlling accumulation and discharge in the inductor in the on/off state; an oscillator which outputs a signal having a frequency at which the switching element operates such that power is supplied from the inductor to the light source through the diode, where the power is in the range between an upper limit and a lower limit determined by the inductance of the inductor and is dependent on a load capacitance of the light source selected by the switch unit; and a chopper circuit driving unit which generates a signal whose duty ratio is the same as that used to supply power to the light source selected by the switch unit according to the load capacity of the light source and whose switching frequency is the same as that of a signal output from the oscillator, and operates the switching element in response to the generated signal.

As a result, the oscillator may output a signal having a frequency dependent on the load capacity of the light source selected by the switch unit. In addition, a signal may be generated whose duty ratio is the same as that used to supply power to the light source selected by the switching unit according to the load capacity of the light source. Therefore, the power output from the chopper circuit can change within a specific range according to the load capacitance of the light source.

### BRIEF DESCRIPTION OF THE DRAWINGS

The above and other features of the present invention will become more apparent by describing in detail exemplary embodiments thereof with reference to the attached drawings in which:

FIG. 1 is a circuit diagram of a light source driver connected with light emitting diodes (LEDs) according to an exemplary embodiment of the present invention;

FIG. 2 is a view explaining the operation of the light source driver of FIG. 1;

FIG. 3 is a graph of an inductor current over time in the light source driver of FIG. 1;

FIG. 4 is a graph of an inductor current over time in the light source driver of FIG. 1;

FIG. 5 is a graph of an inductor current over time in the light source driver of FIG. 1;

FIGS. 6A to 6C are views explaining the operation of the light source driver of FIG. 1;

FIG. 7 is a circuit diagram of a related art light source driver;

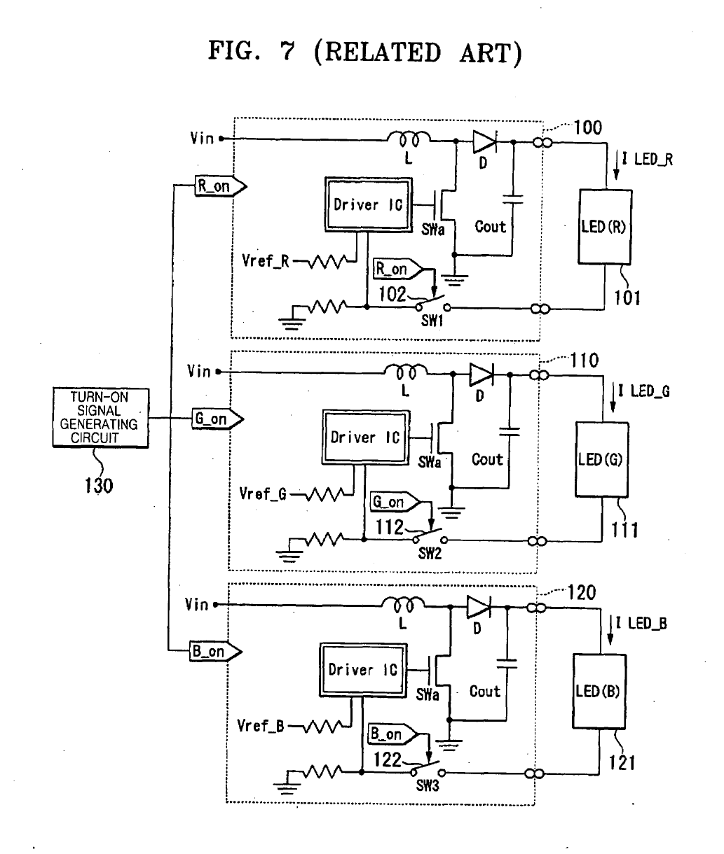

FIGS. 8A to 8C are views explaining the operation of the related art light source driver of FIG. 7;

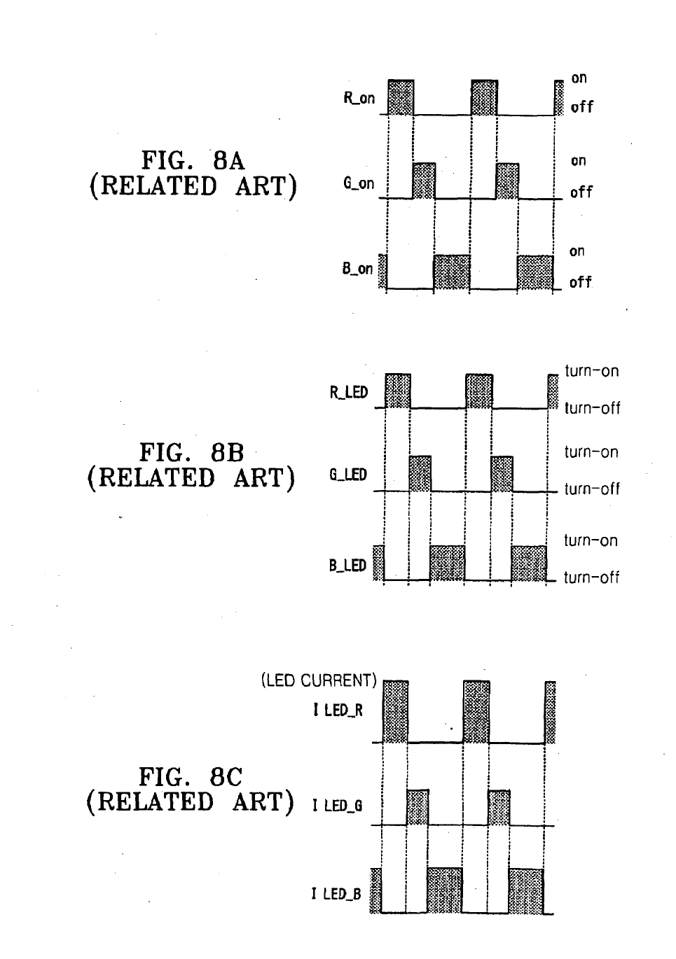

FIG. 9 is a circuit diagram of a related art light source driver commonly shared by a plurality of light sources;

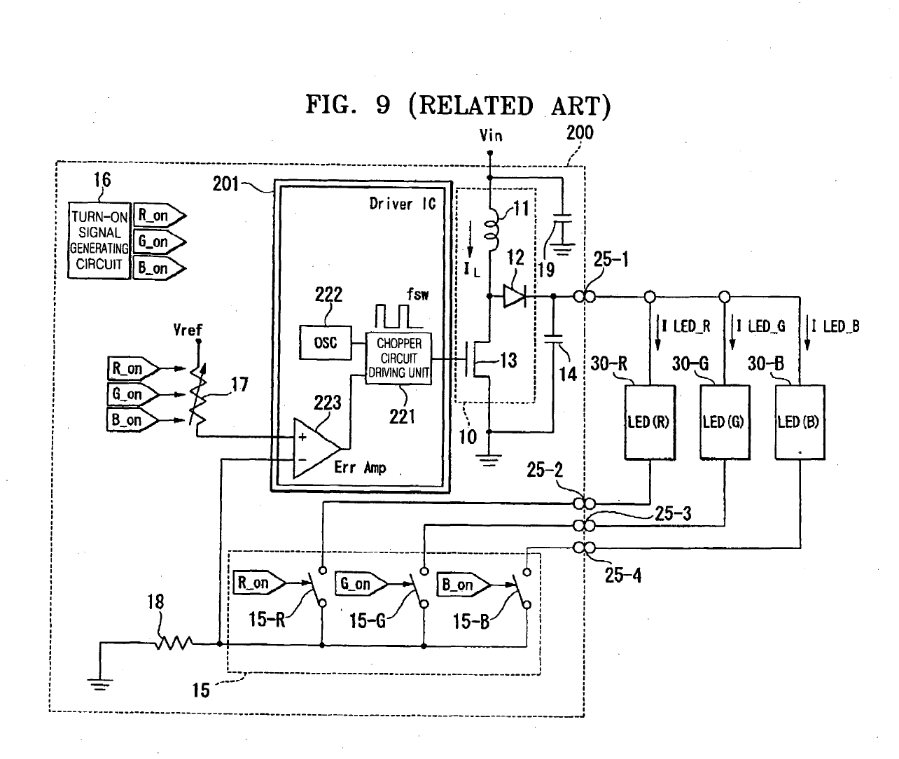

FIGS. 10A to 10C are views explaining the operation of the related art light source driver of FIG. 9;

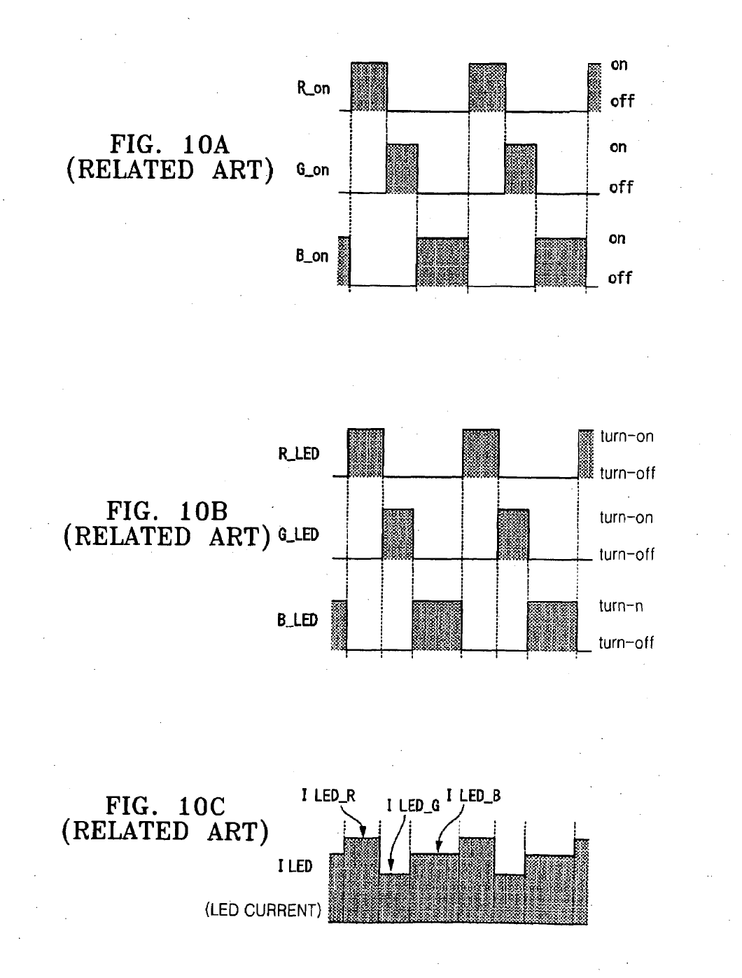

FIG. 11 is a graph of an inductor current in the related art light source driver of FIG. 9; and

FIG. 12 is a graph of an inductor current in the related art light source driver of FIG. 9.

### DETAILED DESCRIPTION OF THE INVENTION

Exemplary embodiments of the present invention will now be described in detail with reference to the accompanying drawings.

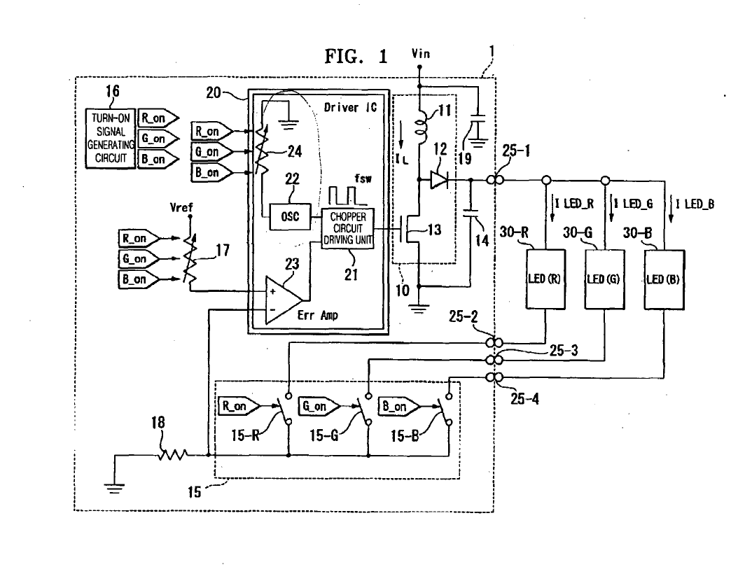

FIG. 1 is a circuit diagram of a light source driver 1 connected to a red LED 30-R, a green LED 30-G, and a blue LED 30-B through connection terminals 25-1 to 25-4.

Referring to FIG. 1, the red LED 30-R, the green LED 30-G, and the blue LED 30-B each have different load capacities.

In the light source driver 1, a turn-on signal generating circuit 16 outputs turn-on signals R_on, G_on, and B_on which are respectively used to turn on the LEDs 30-R, 30-G, and 30-B by time division. A driver IC 20 generates a signal that controls the operation of a chopper circuit 10 in response to the turn-on signals R_on, G_on, and B_on. The chopper circuit 10 performs a switching operation in response to a signal input from the driver IC 20 to provide a current according to the load capacity of the LEDs 30-R, 30-G, and 30-B. A switch unit 15 includes switches 15-R, 15-G, and 15-B respectively connected to first ends of the LEDs 30-R, 30-G, and 30-B. The switches 15-R, 15-G, and 15-B are switched in response to the turn-on signals R_on, G_on, and B_on output from the turn-on signal generating circuit 16, to select any one of the switches 15-R, 15-G, and 15-B. A first end of a variable resistor 17 is connected to a direct current (DC) voltage Vref. The resistance of the variable resistor 17 varies in response to the turn-on signals R_on, G_on, and B_on, and thus target current required to turn on the LEDs 30-R, 30-G, and 30-B is supplied to the driver IC 20.

The chopper circuit 10 includes an inductor 11, of which one end is connected to a DC voltage Vin, and a field effect transistor (FET) 13. The inductor 11 accumulates energy when the FET 13 is in an on-state, and outputs the accumulated energy when the FET 13 is in a off-state. Thus, an inductor current I_{L} is provided according to a switching frequency of the FET 13. A diode 12 is connected to the LEDs 30-R, 30-G, and 30-B through the connection terminal 25-1, to rectify the inductor current I_{L} provided as an LED current. As a switching element, the FET 13 has a gate connected to the driver IC 20 and a drain connected to the inductor 11 and the diode 12. The FET 13 switches the inductor 11 by repeating on/off operations in response to a signal output from the driver IC 20. A capacitor 19 is connected to an input node of the inductor 11 to remove a high frequency component of the DC voltage Vin. A capacitor 14 is connected to an output node of the diode 12 to remove a high frequency component of a current output from the diode 12.

The driver IC 20 includes an oscillator 22 connected to a variable resistor 24. The resistance of the variable resistor 24 varies in response to the turn-on signals R_on, G_on, and B_on. A signal having a switching frequency f_{sw} is input to a chopper circuit driving unit 21, where the switching frequency f_{sw} is dependent on the resistance of the variable resistor 24. The oscillator 22 is constructed such that the lower the resistance of the variable resistor 24, the lower the switching frequency f_{sw}.

An error amplifier (err amp) 23 may be an operational amplifier (op amp). A negative input node of the err amp 23 is connected to the switch 15 and a resistor 18. A positive input node of the err amp 23 is connected to the variable resistor 17. The err amp 23 provides an output signal to the chopper circuit driving unit 21, wherein the output signal is generated according to the difference between the target current provided through the variable resistor 17 and the current input from the switch 15.

The chopper circuit driving unit 21 generates a signal having the switching frequency f_{sw} output from the oscillator 22 and then supplies the signal to the gate of the FET 13. The duty ratio of the signal is determined according to the magnitude of a signal input from the err amp 23.

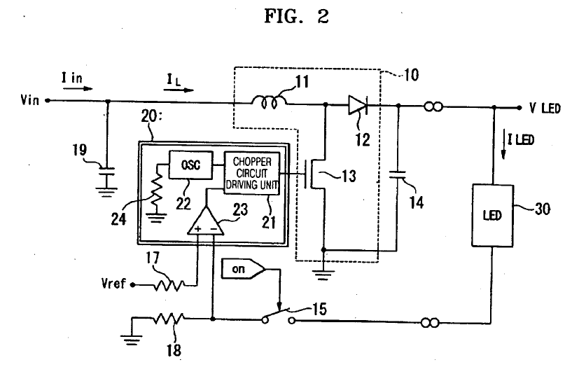

The operation of the light source driver 1 will now be described with reference to FIGS. 2 to 5. Referring to FIG. 2, any one of red, green, and blue LEDs has been selected, and the selected LED is indicated by an LED 30. In addition, the resistance of a variable resistor 24 connected to an oscillator 22 and a switch 15, and the resistance of a variable resistor 17 connected to one end of an err amp 23 are determined by the selected LED.

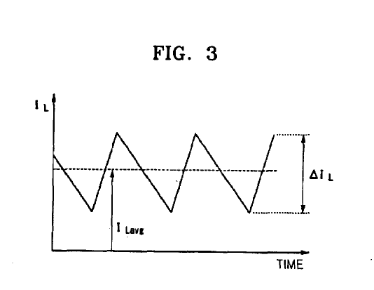

In FIG. 3, a ripple current ΔI_{L} of an inductor 11 and an input voltage Vin can be expressed by Equation 1.

$$Vin := L \frac{Δ {I}_{L}}{Δ t} \qquad [ Equation 1 ]$$

Here, L denotes the inductance of the inductor 11, and Δt denotes a time period when an FET 13 is in an on-state. An average current I_{Lavg} of the inductor 11 with respect to the input voltage Vin, an LED current ILED, and an LED voltage VLED can be expressed by Equation 2.

$${I}_{Lavg} := \frac{1}{Eff} \cdot \frac{VLED}{Vin} \cdot ILED \qquad [ Equation 2 ]$$

Here, Eff denotes the input/output efficiency of a chopper circuit 10. According to Equations 1 and 2, a peak current I_{Lpeak} of the inductor 11 can be expressed by Equation 3. An inductor current I_{L} has a waveform shown in FIG. 3.

$${I}_{Lpeak} := \frac{1}{Eff} \cdot \frac{VLED}{Vin} \cdot ILED + \frac{1}{2} \cdot ( Vin \cdot \frac{VLED - Vin}{L \cdot fsw \cdot VLED} ) \qquad [ Equation 3 ]$$

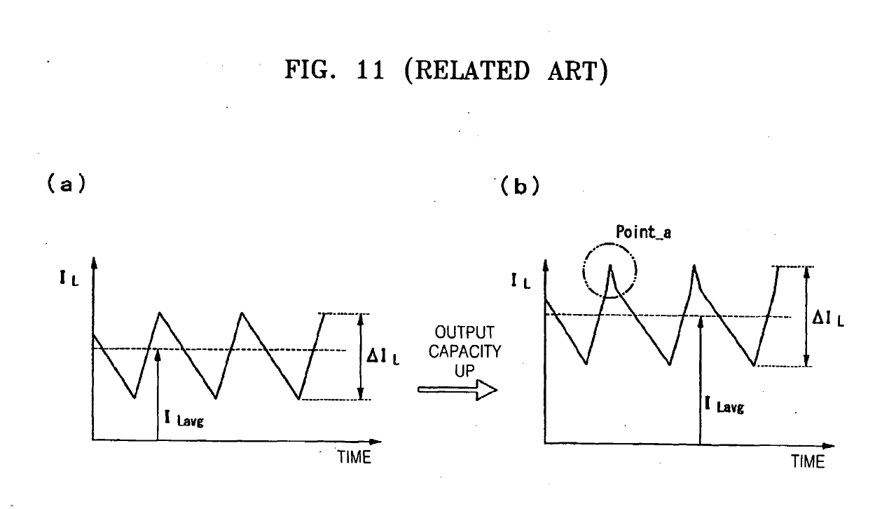

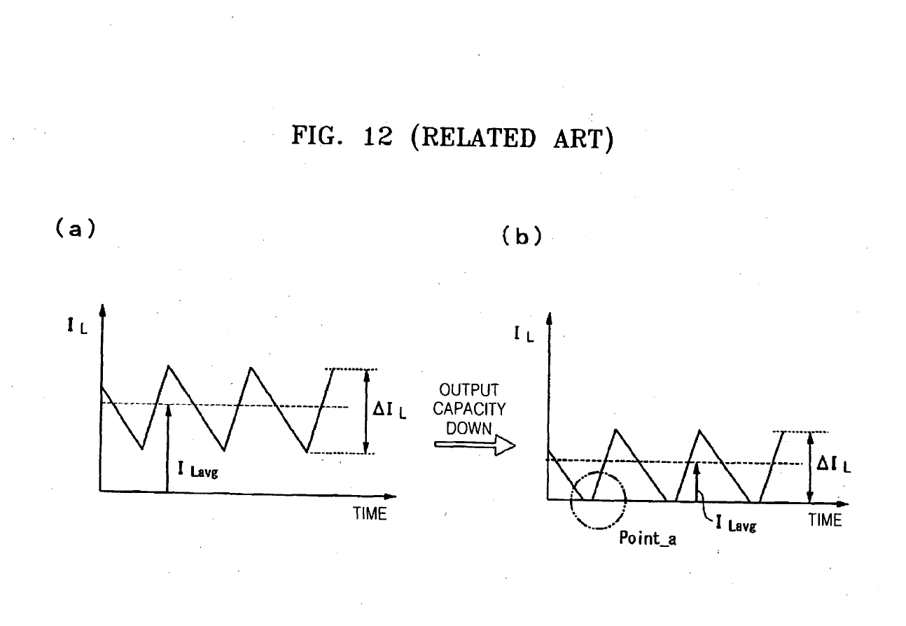

Here, f_{sw} denotes a switching frequency of the FET 13, which is output from the oscillator 22. According to Equation 3, the inductor current I_{L} increases or decreases with the LED current ILED. The LED current ILED varies with a load capacity of the LED 30. When the target current input to a positive input node of the err amp 23 increases to exceed the upper limit at which the inductor 11 is saturated, the inductor current I_{L} is saturated as shown in FIG. 11(b) described above. As a result, the turn-on operation of the LED 30 becomes unstable, and the operation of a driver IC 20 stops. On the other hand, when the target current decreases so that insufficient energy is accumulated in the inductor 11, the inductor current I_{L} is interrupted as shown in FIG. 12(b) described above, causing flashing of the LED 30.

Referring to the second term on the right side of Equation 3, the switching frequency f_{sw} is inversely proportional to the inductor current I_{L}. That is, the inductor current I_{L} decreases as the switching frequency f_{sw} increases, and the inductor current I_{L} increases as the switching frequency f_{sw} decreases.

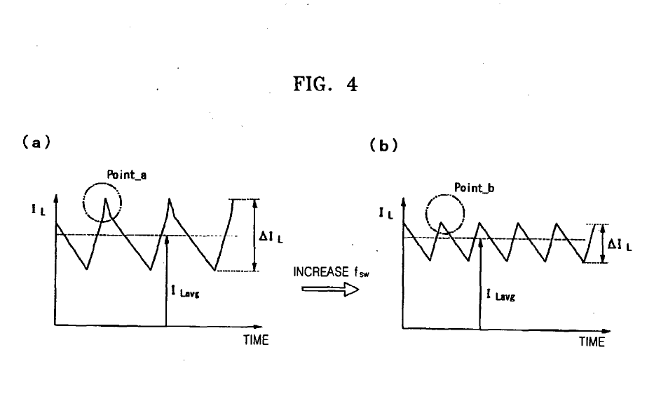

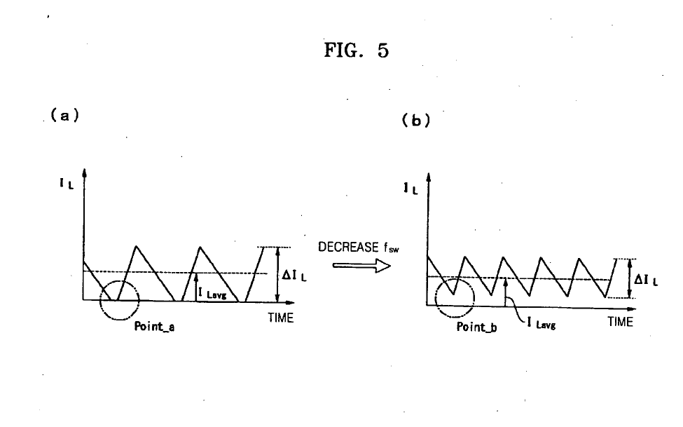

Thus, when the inductor current I_{L} is saturated as shown in FIG. 4, the inductor current I_{L} can decrease by increasing the switching frequency f_{sw}. As a result, the inductor current I_{L} can remain below the upper limit at which the inductor 11 is saturated. In addition, as shown in FIG. 5, when the inductor current I_{L} is interrupted, the inductor current I_{L} can increase by decreasing the switching frequency f_{sw}. As a result, the inductor current I_{L} enables the inductor 11 to repeat a normal cycle for accumulating and discharging energy, thereby preventing the inductor current I_{L} from being interrupted.

The switching frequency f_{sw} may significantly affect the FET 13. When the FET 13 is highly affected by the increase of the switching frequency f_{sw}, the input/output efficiency of the light source driver 1 may deteriorate. Therefore, when the switching frequency f_{sw} increases to avoid saturation, the switching frequency f_{sw} has to remain below the upper limit to prevent input/output efficiency deterioration.

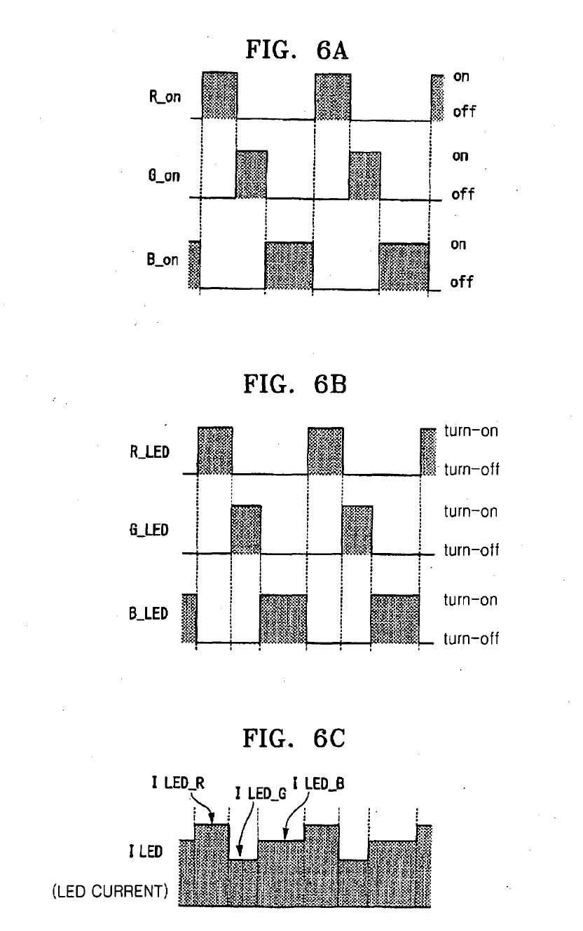

The operation of the light source driver 1 will now be described with reference to FIGS. 1 and 6. It will be assumed that the red LED 30-R, the green LED 30-G, and the blue LED 30-B each has a different load capacity. In addition, an LED current ILED_R for the red LED 30-R is higher than an LED current ILED_B for the blue LED 30-B, which is in turn higher than an LED current ILED_G for the green LED 30-G.

For example, the turn-on signal R_on may be output from the turn-on signal generating circuit 16 to turn on the red LED 30-R. In this case, the output turn-on signal R_on changes the resistance of the variable resistor 24 of the driver IC 20 to be lower than the case when the turn-on signal G_on or B_on is output. The output turn-on signal R_on also allows the resistance of the variable resistor 17 connected to the positive input node of the err amp 23 to be lower than the case when the turn-on signal G_on or B_on is output. That is, the resistance of the variable resistor 17 changes so that the target current input to the positive input node of the err amp 23 is maximized. In this case, the switch 15-R of the switch unit 15 is in an on-state, and the switches 15-G and 15-B of the switch 15 are in an off-state.

According to the changed resistance of the variable resistor 24, the oscillator 22 of the driver IC 20 provides the chopper circuit driving unit 21 with a signal having the switching frequency f_{sw}. This switching frequency f_{sw} is lower than the case when the green LED 30-G or the blue LED 30-B is selected. The err amp 23 supplies a signal to the chopper circuit driving unit 21, wherein the signal is generated according to the difference between the target current input to the positive input node of the err amp 23 through the variable resistor 17 and the current input to the negative input node of the err amp 23 through the switch 15-R.

The chopper circuit driving unit 21 generates a signal having the switching frequency f_{sw} output from the oscillator 22, and then supplies it to the gate of the FET 13. The duty ratio of the signal is determined according to the magnitude of a signal input from the err amp 23. The target current for the red LED 30-R is higher than the target current for the LED 30-G or LED 30-B. The duty ratio increases when the FET 13 is in the on-state since the switching operation of the FET 13 results in significant current variation.

The FET 13 of the chopper circuit 10 is switched in response to a signal received through the gate of the FET 13, and thus the inductor 11 generates the inductor current I_{L}. The inductor current I_{L} is rectified by the diode 12 and then supplied as the LED current ILED_R to the LED 30-R.

Afterwards, according to the timing sequence shown in FIG. 6A, the green turn-on signal G_on and the blue turn-on signal B_on are sequentially turned on. Then, the red turn-on signal R_on, the green turn-on signal G_on, and the blue turn-on signal B_on are repeatedly turned on, in that order.

When the turn-on signal G_on is output from the turn-on signal generating circuit 16, the switching frequency f_{sw} output from the oscillator 22 is higher than the case when the turn-on signal R_on or the turn-on signal B_on is output. The target current input to the positive input node of the err amp 23 is lower than the case when the turn-on signal R_on or the turn-on signal B_on is output. An LED current ILED_G shown in FIG. 6C is supplied to the LED 30-G.

When the turn-on signal B_on is output from the turn-on signal generating circuit 16, the switching frequency f_{sw} output from the oscillator 22 is higher than the case when the turn-on signal R_on is output, and lower than the case when the turn-on signal B_on is output. The target current input to the positive input node of the err amp 23 is lower than the case when the turn-on signal R_on is output, and higher than the case when the turn-on signal B_on is output. An LED current ILED_B shown in FIG. 6C is supplied to the LED 30-B. Therefore, each of the LEDs 30-R, 30-G, and 30-B is turned on/off as shown in FIG. 6B.

According to the structure of the aforementioned exemplary embodiment, if the inductor 11 is saturated by a high current supplied to the LEDs 30-R, 30-G, and 30-B each having a different load capacitance, the oscillator 22 outputs the low switching frequency f_{sw} to reduce the inductor current I_{L}, thereby avoiding saturation. If the supply of a low current results in interruption of the inductor current I_{L}, the oscillator 22 outputs the high switching frequency f_{sw}, thereby avoiding interruption. Accordingly, a current can be supplied properly to each of the LEDs 30-R, 30-G, and 30-B even at high brightness, and the light source driver 1 can be commonly shared by the LEDs 30-R, 30-G, and 30-B each having a different load capacitance. Therefore, it is possible to minimize the overall equipment size.

In addition, the target current is input to the positive input node of the err amp 23, and a current supplied to the LEDs 30-R, 30-G, and 30-B is controlled according to the duty ratio of the signal generated by the chopper circuit driving unit 21, where the duty ratio is determined by the magnitude of the signal output from the err amp 23. However, the present invention is not limited to this structure. For example, an exemplary embodiment of the present invention may employ another structure in which a target voltage for the LEDs 30-R, 30-G, and 30-B is input to the positive input node of the err amp 23, and a voltage supplied to the LEDs 30-R, 30-G, and 30-B is fed back to the native input node of the err amp 23, so that a duty ratio is computed using that voltage.

In addition, the variable resistor 17 and the variable resistor 24 are used to set the currents of signals input respectively to the positive input node of the err amp 23 and the oscillator 22. However, the present invention is not limited to the variable resistors 17 and 24, and thus any element may be used as long as it can produce a current or a voltage in response to a signal.

According to an exemplary embodiment of the present invention, a light source driver driving a plurality of light sources each having a difference load capacity includes: a switch unit which selects any one of the light sources by switching from one light source to another; a chopper circuit which has an inductor connected to a power source, a diode connected to the light source selected by the switch unit, and a switching element supplying power accumulated in the inductor to the light source through the diode by controlling an on/off state of the inductor in such a manner that the power is accumulated in the inductor in the on state and discharged from the inductor in the off state; an oscillator which outputs a signal having a frequency at which the switching element operates such that power is supplied from the inductor to the light source through the diode, where the power is in the range between an upper limit and a lower limit determined by the inductance of the inductor and is dependent on a load capacity of the light source selected by the switch unit; and a chopper circuit driving unit which generates a signal whose duty ratio is the same as that used to supply power to the light source selected by the switch unit according to the load capacity of the light source and whose switching frequency is the same as that of a signal output from the oscillator, and operates the switching element in response to the generated signal.

Therefore, the chopper circuit, the chopper circuit driving unit, and the oscillator can be commonly shared by a plurality of light sources, thereby aiding miniaturization of a light source driver. In addition, power can be provided according to a load capacity of each light source, thereby realizing high brightness of the light source driver.

What is claimed is:

1. A light source driver which drives a plurality of light sources each having different load capacity, the light source driver comprising:
a switch unit which selects one light source of the plurality of light sources;
a chopper circuit which has an inductor connected to a power source, a diode connected to the selected light source, and a switching element which supplies power accumulated in the inductor to the selected light source through the diode by controlling an accumulation and discharge in the inductor in the on/off state;
an oscillator which outputs a first signal having a frequency at which the switching element operates such that the power is supplied from the inductor to the selected light source through the diode, where the power is in a range between an upper limit and a lower limit determined by an inductance of the inductor and is dependent on a load capacity of the selected light source selected by the switch unit; and
a chopper circuit driving unit which generates a second signal having a duty ratio equal to a duty ratio used to supply the power to the selected light source according to a load capacitance of the selected light source, and a switching frequency equal to a switching frequency of the first signal, and operates the switching element in response to the generated second signal.

2. The light source driver of claim 1, wherein the power is in the range between the upper limit and the lower limit determined by the inductance of the inductor if the power supplied from the inductor is not saturated or interrupted.

3. The light source driver of claim 1, wherein if low power is required for the selected light source, the first signal has a higher frequency than if high power is required for the load capacity.

4. A light source driver which drives a plurality of light sources of different load capacities and receives turn-on signals for the plurality of light sources, the light source driver comprising:
a driver circuit which generates a signal;
a chopper circuit which selects a light source from the plurality of light sources in response to the signal generated from the driver circuit.

5. The light source driver of claim 4, wherein the driver circuit further comprises:
a variable resistor, wherein a resistance of the variable resistor varies in response to the turn-on signals for the plurality of light sources, and wherein the signal is generated based on resistance of the variable resistor.

6. The light source driver of claim 5, wherein the signal has a frequency which is dependent on the resistance of the variable resistor.

7. The light source driver of claim 6, wherein the driver circuit further comprises:
an oscillator which generates the signal, wherein the frequency of the signal is proportional to the resistance of the variable resistor.
